(19) United States
(12) Patent Application Publication
(10) Pub. No.: US 2003/0088954 A1
(43) Pub. Date: May 15, 2003

(54) Secure storage system for cremation urns

(75) Inventor: Patrick Mainville, Montreal (CA)

Correspondence Address: COLLARD & ROE, P.C., 1077 Northern Boulevard, Roslyn, NY, 11576-1696, US

(73) Assignee: MEMORIALIZATION SYSTEMS OF AMERICA

(21) Appl. No.: 10/335,728

(22) Filed: Jan. 2, 2003

Related U.S. Application Data
(62) Division of application No. 09/698,466, filed on Oct. 27, 2000, now Pat. No. 6,513,352.

(51) Int. Cl. A61G 17/00

(52) U.S. Cl. 27/1; 27/35; 70/166

(57) ABSTRACT

A locking mechanism for locking a cremation urn inside a columbarium chamber or to another appropriate wall surface and a hidden lock for a funeral chamber shutter system are disclosed. The locking mechanism includes a male locking member which is rigidly securable to a wall surface and a female receiving member in one of the top walls, bottom walls and sidewalls of the cremation urn. The female receiving member is securely interlockable with the male locking member. The locking mechanism also includes fastening means for securing the male locking member to the wall surface.

### BACKGROUND

The present invention relates to the storage of cremation urns and more particularly concerns security mechanisms for preventing the unauthorized removal of the urns from their storage location.

The ashes of deceased individuals are generally kept in cremation urns, which are themselves stored in a columbarium. Columbaria usually have a plurality of niches each adapted to receive one or two cremation urns and each niche has an access opening in the front closed by a shutter panel. A columbarium can be installed indoors or outdoors. Due to the solemn nature of these installations, it is desirable that the columbarium and its components be of a subdued design. Usually, the walls of a columbarium are made of granite or marble and the shutter panels are formed in flat slabs of the same materials.

Vandalism of columbaria and theft of cremation urns are problems often encountered in the field, causing distress to the families of the deceased. A measure used to prevent theft of the cremation urns is to lock the urns themselves inside the columbarium niches. It is known in the art to use screws or glue for this purpose, but the result can be unsightly and ineffective. There is therefore a need for a hidden and efficient locking mechanism for locking a cremation urn inside a columbarium chamber or to any other structure in which it is stored or displayed.

Additionally, a further security feature used in the field is to prevent the shutter panels of the columbarium niche from being opened without authorization. Unsightly locks installed on the columbarium niches are however to be avoided. The same problem is encountered in the field of mausaleum chambers used to store caskets, which may be built along a design similar to columbarium niches. It is known in the art to lock the shutter panels with tamper-resistant hardware, but again, these measures are not always effective and can be aesthetically displeasing. There is therefore a need for a discreet yet effective locking mechanism for the shutter panels of a funeral chamber.

### SUMMARY OF THE INVENTION

It is an object of the present invention to provide a storage system for funeral remains that prevents the theft of the same.

It is a more particular object of the invention to provide a discreet locking mechanism for locking a cremation urn inside a columbarium chamber or to another appropriate wall surface.

It is another object of the invention to provide a hidden lock on a shutter system of a funeral chamber.

According to a first aspect of the present invention, there is provided a locking mechanism for locking a cremation urn to a wall surface, the cremation urn itself having a top wall, a bottom wall and at least one sidewall.

The locking mechanism includes a male locking member which is rigidly securable to the wall surface, and a female receiving member in one of the top wall, bottom wall and sidewall of the cremation urn. The female receiving member is securely interlockable with the male locking member. The locking mechanism also includes fastening means for securing the male locking member to the wall surface.

In addition, in accordance with a second aspect of the present invention, there is provided a shutter system for a funeral chamber, such as a columbarium niche or a mausaleum chamber. The funeral chamber has a rim outlining a substantially rectangular front opening, this rim including two pairs of opposite sides.

The shutter system includes a shutter panel for covering the front opening. The panel has a front face, a back face and two pairs of opposite edges. Mounting means are provided for mounting the shutter panel to the funeral chamber, and include both a frame connected to the back face of the shutter panel, and a hooking member connected to this frame. The hooking member projects away from the back face of the shutter panel and is proximate to one of the edges of the shutter panel. The hooking member also extends in a plane generally perpendicular to the back face and generally parallel to one of the edges of the shutter panel.

The shutter system also includes a resilient member affixable to one of the sides of the rim and protruding outwardly from the same once affixed. The resilient member is engageable with the hooking member of the frame.

A key shaped to disengage the hooking member from the resilient member is finally provided.

The present invention and its advantages will be better understood upon reading the following non-restrictive description of embodiments thereof with reference to the accompanying drawings.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is an exploded view of a cremation urn provided with a locking mechanism according to an embodiment of the invention;

FIG. 2A is a cross-sectional view of the positioning of a connector inside the female receiving member according to a first embodiment of the invention; FIG. 2B is a cross-sectional view of the positioning of a connector inside the female receiving member according to a second embodiment of the invention; and FIG. 2C is a perspective view of a male locking member as shown in FIG. 2B;

FIG. 3A is a top and partially transparent view of a columbarium niche having two cremation urns stored therein; and FIG. 3B is a top and partially transparent view of a columbarium niche having one cremation urn stored therein;

FIG. 4 is a perspective view of a columbarium niche provided with an urn locking mechanism and the resilient member of a shutter system according to various aspects of the present invention;

FIG. 5A is a perspective view of a shutter panel provided with mounting means for mounting the same to a columbarium niche according to a preferred embodiment of the invention; FIG. 5B is a back view of the shutter panel of FIG. 5A; FIG. 5C is a side view of the shutter panel of FIG. 5A; and FIG. 5D is a top view of the same;

FIG. 6 is a perspective view showing a shutter system according to a preferred embodiment of the invention, when open; and

FIG. 7 is a top view in partial transparency of the shutter system of FIG. 6, when closed.

### DETAILED DESCRIPTION

The present invention offers a secure storage system for funeral remains, to prevent vandalism and theft thereof. The present invention includes two main aspects, that is, a locking mechanism for cremation urns inside a columbarium niche or attached to any other appropriate wall surface and a shutter system for preventing the opening of funeral chamber such as a columbarium niche, a mausaleum chamber or the like.

Description of the Locking Mechanism for a Cremation Urn

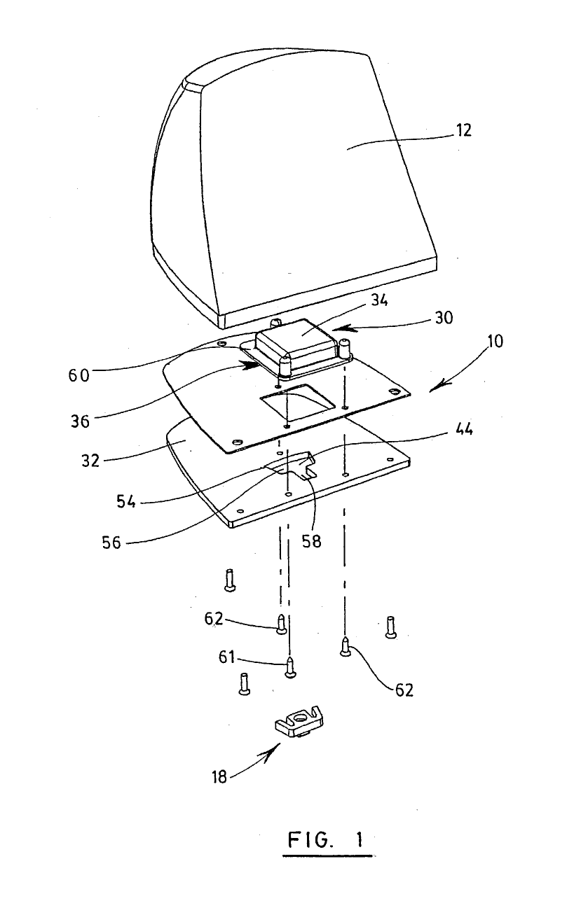

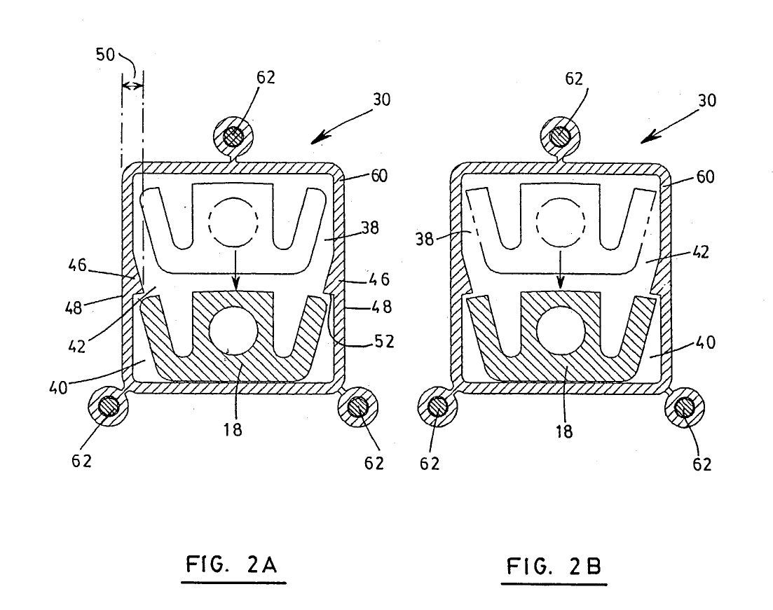

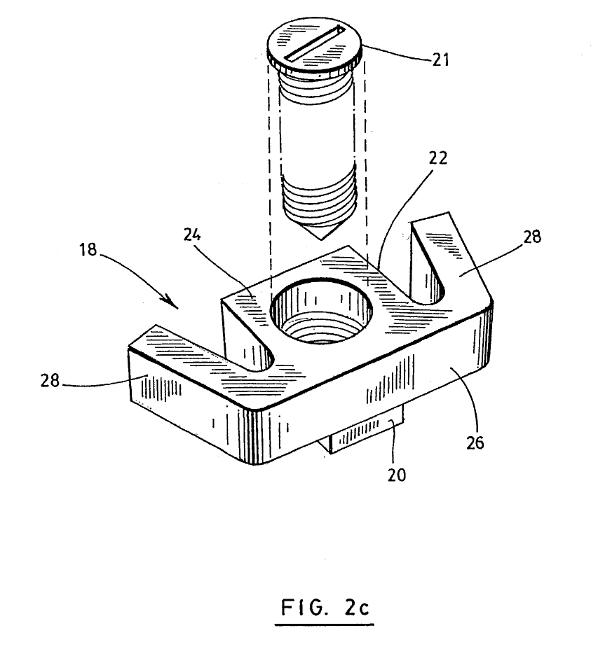

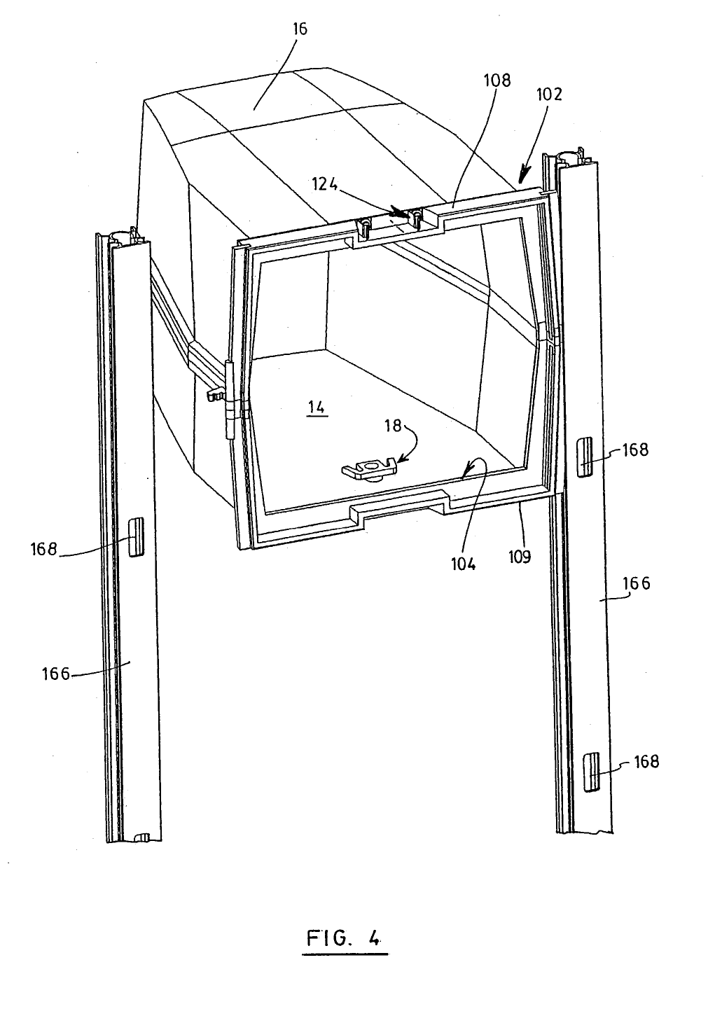

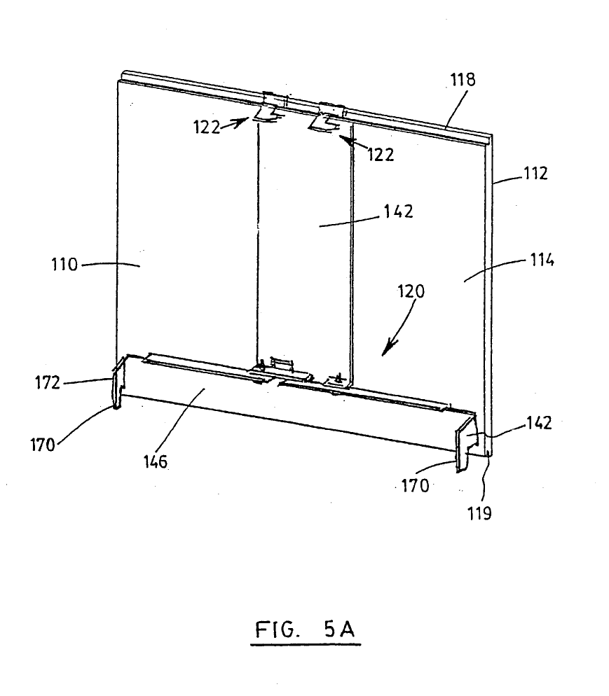

In accordance with a first aspect of the invention and with reference to FIGS. 1, 2A , 2B and 2C, there is provided a locking mechanism 10 for locking a cremation urn 12 to a wall surface. In the illustrated embodiment the wall surface is a bottom wall 14 of a columbarium niche 16 (see FIG. 4), however, it is understood that the cremation urn 12 could be locked to any other wall of the columbarium niche or to another structure, such as for example, a pedestal, without departing from the scope of the invention.

Referring to FIG. 2C, the locking mechanism first includes a male locking member 18 which, when installed, is rigidly secured to the bottom wall 14. Fasteners are provided for this purpose, such as, for example, a screw. Preferably the male locking member 18 has two main parts, a base 20 securable to the wall surface and a connector 22 topping the base 20. Means to secure the base 20 to the wall surface, such as a screw 21 or a rivet are provided. The connector 22 preferably has a generally rectangular body portion 24 and a resilient portion 26 having a pair of resilient arms 28 generally extending along opposite sides of the body portion 24.

Referring to FIGS. 1, 2A and 2B, the locking mechanism 10 also includes a female receiving member 30 in one of the walls of the cremation urn 12. In the preferred embodiment, the female receiving member 30 includes a rectangular-shaped box 34 having an open face 36 and which when installed, is mounted inside the bottom wall 32 of the cremation urn 12 1 0 with its open face down. In the illustrated embodiment, a collar 60 extends around the open face 36 of the rectangular-shaped box 34, and, once installed, is rigidly connected to the bottom waIl 32 of the cremation urn 12. Screws 62 may for example be provided for this purpose. The female receiving member 30 is securely interlockable with the male locking member 18, in the manner explained below.

The female receiving member preferably includes a first chamber 38, a second chamber 40 and a passage 42 therebetween, all of which are preferably included inside the rectangular-shaped box 34. The first chamber 38 has an entryway 44 for receiving the connector 22 of the male locking member 18. The connector 22 may then be slid through the passage 42 to the second chamber 40, which holds it in place. To this effect, the passage 42 preferably narrows progressively towards the second chamber 40, which compresses the two resilient arms 28 inwards towards the body 24 of the connector 22 when it is slid through the passage 42. The arms 28 then substantially return to their original shape once in the second chamber 40 which locks the connector 22 therein. As may be seen on FIGS. 2A and 2B, a pair of aligned flanges 46 are preferably disposed on opposed sides 48 of the passage 42. Each flange 46 has a width 50 increasing from the first to the second chamber 38 and 40, so as to define the progressive narrowing of said passage 42, and forms a shoulder 52 in the second chamber 40 for engaging the arms 28 of the connector 22, once in the second chamber 40.

To prevent the connector 22 from being removed perpendicularly from the second chamber 40, the female receiving member 30 preferably includes an opening 54 in the bottom wall 32 of the cremation urn 12, having a first and a second section 56 and 58. The first section 56 is shaped to receive the connector 22 thereth rough, and is aligned with the first chamber 38 when the box 34 is mounted in the cremation urn 12. The first section 56 thereby defines the entryway 44 of the first chamber 38. The second section 58 is aligned with the passage 42 and the second chamber 40, and is shaped to allow the base 20 of the male locking member 18 to protrude therethrough when the connector 22 is slid from the first to the second chamber 38 and 40. In this manner, the connector 22 is effectively held inside the second chamber 40.

In accordance with a first embodiment of the invention disclosed in FIG. 2A, the male locking member 18 may be releasable from the second chamber 40 by turning the cremation urn in a specific manner. For this purpose, the bottom ends of the arms 28 are rounded, allowing them to disengage from the shoulders 52. In a second embodiment, shown in FIG. 28, the ends of the arms 28 are rectangular-shaped so that the male locking member cannot be disengaged from the female receiving member 30.

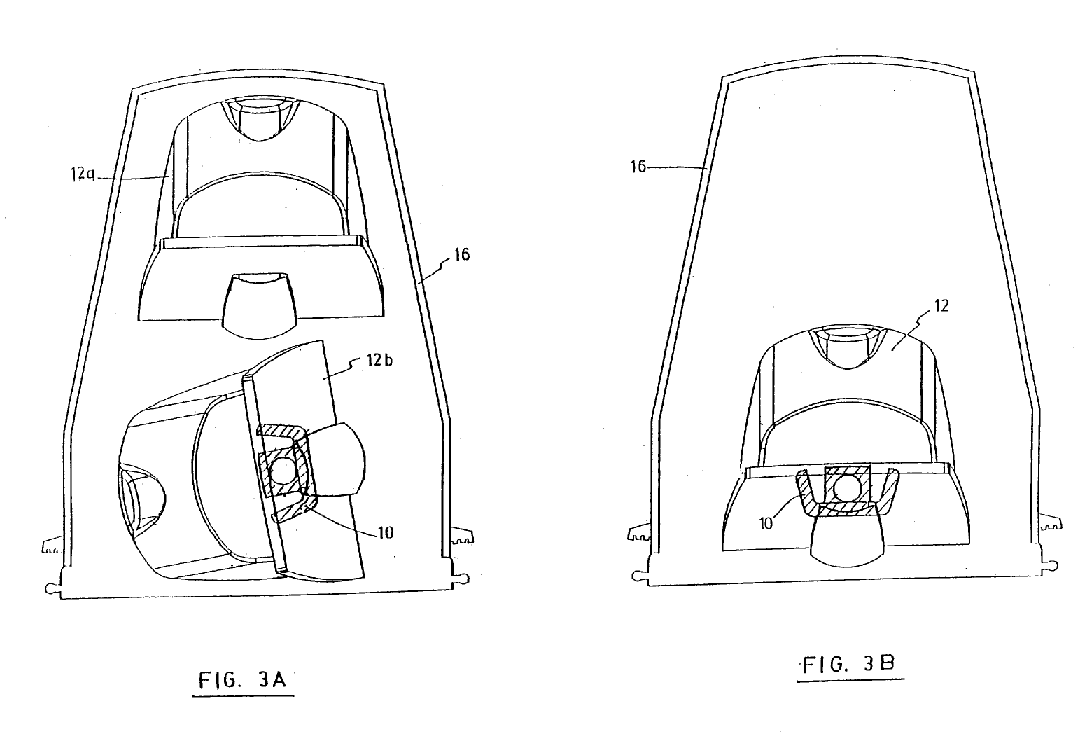

Of course, more than one locking mechanism may be installed inside a single columbarium niche 16. FIG. 3A illustrates the possible positioning of two locking mechanisms 10 inside a niche 16, for holding two cremation urns 12. In this embodiment, the cremation urn 12a in the back of the columbarium niche 16 does not need to be locked down, since the front urn 12b blocks access to it. Therefore, a single locking mechanism 10 is installed in the front of the niche 16 offset from the center thereof, so that the front cremation urn 12b may be installed sideways. Alternatively, the single mechanism 10 may be disposed centred in the front to receive a single cremation urn 12, as shown in FIG. 3B. As previously mentioned, it should be understood that the present invention is not limited for use in columbarium niches but may be used to lock a cremation urn to any appropriate wall surface. Additionally, another advantage of the locking mechanism according to the invention is that the male locking member may be of a small enough size not to interfere with the storage of other types of cremation urns in the columbarium niche.

Description of a Shutter System for a Columbarium Niche

In accordance with a second aspect of the invention, and with reference to FIGS. 4, 5A to 5D, 6 and 7, there is also provided a shutter system 100 for a columbarium niche 16. It is understood that the shutter system may be installed on a mausaleum chamber used for the storage of caskets, and that a columbarium niche is illustrated and described herein by way of example. For the purposes of the present invention, it is considered that the columbarium niche 16 has a rim 102 with two pairs of opposite sides, outlining a substantially rectangular front opening 104.

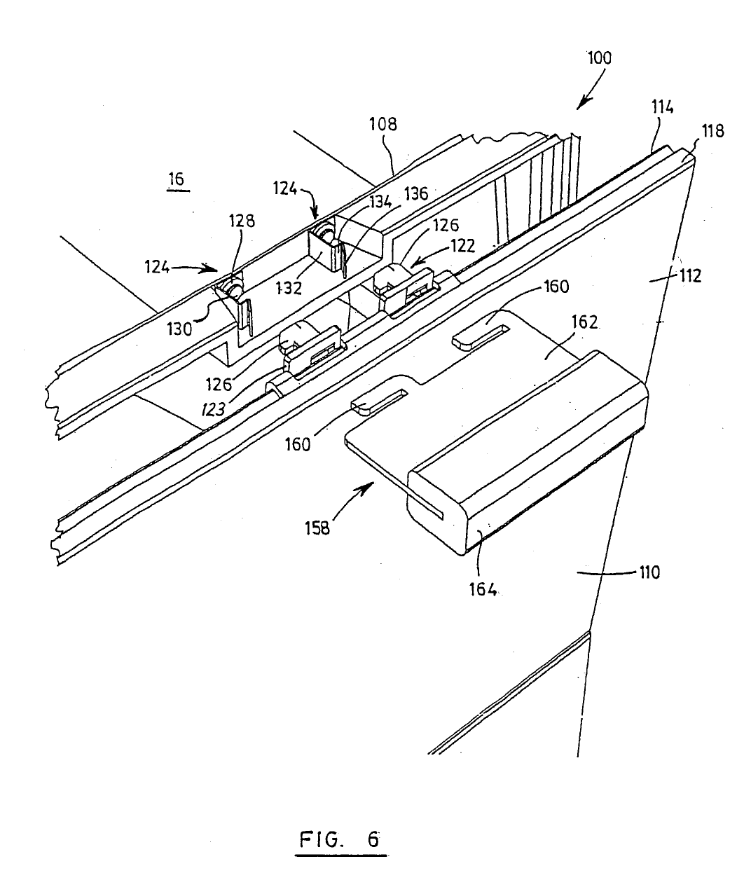

The shutter system includes a shutter panel 110 having a front face 112, a back face 114 and two pairs of opposite edges. The shutter panel 110 is mountable to the columbarium niche 16, so that it covers the front opening 104 as shown in FIG. 6. Means for mounting the shutter panel 110 on the columbarium niche 16 are provided, and may be embodied as follows.

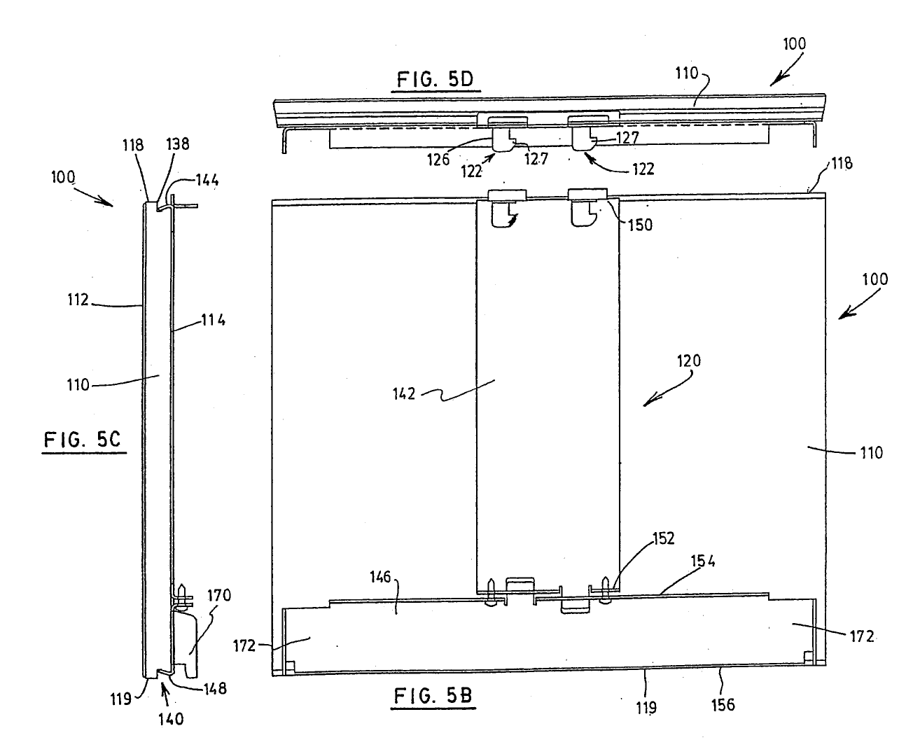

The back face 114 of the panel 110 preferably has a first groove 138 along its top edge 118 and a second groove 140 along its bottom edge 119. Each groove may be formed by inwardly bevelling the corresponding edge or be made inside the back face 114 slightly offset from the edge. A frame 120 is also provided, including a first bracket 142 with a tab 144 insertable in the first groove 138 and a second bracket 146 with a tab 148 insertable in the second groove 140. Both brackets 142 and 146 are preferably made of metal. The first bracket 142 preferably extends longitudinally on the back face 114 of the panel 110 from its top edge 118 towards its bottom edge 119, and has a top end 150 provided with the tab 144 and a bottom end 152 connectable to the second bracket 146. The second bracket 146 extends transversally along the bottom edge 119 of the panel 110. It has a top end 154 connectable with the bottom end 152 of the first bracket 142, and a bottom end 156 provided with the tab 148. Connecting means such as nuts and bolts are provided for removably connecting the first bracket 142 to the second bracket 146 and bringing them closer to clamp the panel 110 between the two tabs 144 and 148, as best shown in FIG. 5C.

Preferably, the shutter system according to the invention is used for a columbarium niche 16 mounted on a pair of vertical side rails 166 extending on either sides thereof, as shown in FIG. 4. The vertical side rails 166 are each provided with hook-receiving slots 168 therein. In this embodiment, two hooks 170 project downwardly from opposite side ends 172 of the second bracket 146, to be engaged in the hook-receiving slots 168 to mount the frame 120 and thus the panel 110, on the columbarium niche 16. In this manner, the lateral movement of both the niches and the shutter panels is prevented.

The shutter system 100 also includes a hooking member 122 connected to the frame 120, and projecting away from the back face 114 of the shutter panel 110. The hooking member 122 is disposed near one of the edges of the shutter panel 110, preferably the top edge 118, and extends in a plane which is generally perpendicular to the back face 114 of the shutter panel 110 and generally parallel to its top edge 118 (or another edge that the hooking member is placed near to). The hooking member 122 may be punched out of the first bracket 142 and therefore be integral thereto.

Referring more particularly to FIG. 6, a resilient member 124 is also provided in the present shutter system to engage the hooking member 122 of the frame 120. The resilient member 124 is affixable to one of the sides of the rim 102 which corresponds to the edge of the frame 120 that the hooking member is proximate to. In the preferred embodiment, the resilient member is therefore affixed to the top side 108 of the rim 102. Once affixed, the resilient member protrudes outwardly from the top side 108 of the rim 102.

In the preferred embodiment, the hooking member 122 has an L-shaped portion 126 extending in the plane defined above, which has a free segment 127 (indicated in FIG. 5D) in a direction substantially parallel to the top edge 118 of the panel 110. The resilient member 124 preferably has a base 128 securable to the top side 108 of the rim 102, and a projection 130 shaped for releasably engaging with the L-shaped portion 126 of the hooking member 122. The projection 130 has three segments, that is, a flexible segment 132 projecting from the base 128, a hooking segment 134 at the end of the flexible segment 132 and substantially perpendicular thereto, and a slanted segment 136 slanting outwardly from the hooking segment 134, and forming an acute angle therewith. The flexible segment 132 has an original position where it is relaxed and an open position where it is bent laterally.

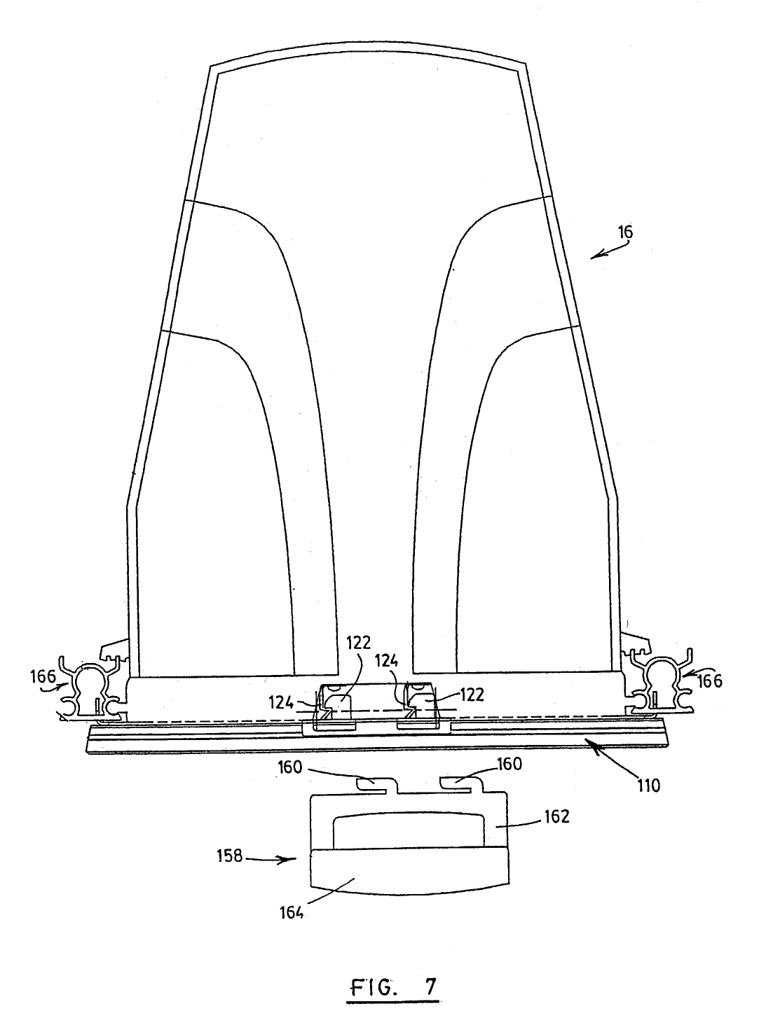

In the embodiment described above, to engage the resilient member 124 with the hooking member 122, the free segment 127 of the L-shaped portion 126 of the hooking member 122, first exercises a pressure on the slanted segment 136 of the projection 130, to move the flexible segment 132 from its original position to the open position. The free segment 127 then slides onto the slanted segment 136 until it reaches the hooking segment 134, and slips behind it. The flexible segment 132 is then free to return to its original position, and the hooking member 122 is thus engaged with the resilient member 124, as shown in FIG. 7.

Referring to FIG. 7, to disengage the hooking member 122 from the resilient member 124, a key 158 is provided, preferably having an L-shaped tab 160 for laterally pushing the projection 130 of the resilient member 124 thereby disengaging the hooking member 122 therefrom. The key 158 also preferably includes a guide 162 for carrying the L-shaped tab 160 to the resilient member 124, and a handle 164 connected to the guide 162. Also preferably, the key 158 including all its components, is punched out of a single piece of metal.

Preferably, a protection post 123 is provided extending upwardly from the top edge 118 of the shutter panel 110, in alignment with the hooking member 122. The protection post 123 makes it difficult to access the resilient member and hooking member from the outside without a proper key.

As may be seen on the appended drawings, two hooking members 122 may be provided in a shutter system according to the invention, without departing from its scope. Of course, in this case, two resilient members 124 are correspondingly provided. The additional hooking member and resilient member may be similar to those described above.

Advantageously, the shutter system as described above, provides a lock on the shutter panel that is invisible from outside, and therefore does not ruin the solemn appearance of the columbarium or masauleum. Preferably, niches are mounted in such a manner that only a small distance is left between adjoining shutter panels, adapted to receive the key therein but making it difficult to unlock the system with another object.

The shutter system according to the present invention may be used with shutter panels made from a multitude of material. For example, the present invention would be especially well adapted for use with slabs of marble or granite known in the art, but other materials such as plastic or metal may easily be considered.

Accordingly, while at least one embodiment of the present invention has been shown and described, it is to be understood that many changes and modifications may be made thereunto without departing from the spirit and scope of the invention as defined in the appended claims.

What is claimed is:

1. A locking mechanism for locking a cremation urn to a wall surface, said cremation urn having a top wall, a bottom wall and at least one sidewall, the locking mechanism comprising:
a male locking member rigidly securable to the wall surface;
a female receiving member in one of the top wall, bottom wall and sidewall of the cremation urn, said female receiving member being securely interlockable with the male locking member; and
fastening means for securing the male locking member to the wall surface.

2. A locking mechanism according to claim 1, wherein:
the male locking member comprises a base securable to the wall surface and a connector topping the base; and
the female receiving member comprises:
a first chamber with an entryway for receiving the connector of the male locking member;
a second chamber for holding said connector;
a passage between the first chamber and the second chamber for allowing said connector to be slid from the first chamber to the second chamber; and
means for locking the connector in the second chamber.

3. A locking mechanism according to claim 2, wherein said connector has a body portion and a resilient portion.

4. A locking mechanism according to claim 3, wherein the body portion is generally rectangular and the resilient portion comprises a pair of resilient arms generally extending along opposite sides of the body portion.

5. A locking mechanism according to claim 4, wherein the means for locking the connector of the locking member in the second chamber comprises a progressive narrowing of the passage towards the second chamber, whereby the two resilient arms are compressed inwards towards the body of the connector upon sliding the same through the passage and are substantially returned to their original shape once in the second chamber to lock the connector therein.

6. A locking mechanism according to claim 5, wherein the female receiving member comprises a pair of aligned flanges on opposed sides of the passage, each flange having a width increasing from the first to the second chamber so as to define the progressive narrowing of said passage.

7. A locking mechanism according to claim 6, wherein each of said flanges forms a shoulder in the second chamber for engaging the arms of the connector when said connector is in said second chamber.

8. A locking mechanism according to claim 2, wherein the female receiving member comprises:
a rectangular-shaped box having an open face, the first chamber second chamber and passage being included in said box, the box being mountable inside the cremation urn with said open face facing said one of the top wall, bottom wall and sidewall; and
an opening in said one of the top wall, bottom wall and sidewall, said opening having a first section shaped to receive the connector therethrough and being aligned with the first chamber when said box is mounted in the cremation urn so as to define the entryway, and a second section aligned with the passage and the second chamber when said box is mounted in the cremation urn, the second section being shaped to allow the base of the male locking member to protrude therethrough when the connector is slid from the first to the second chamber.

9. A locking mechanism according to claim 8, wherein the female receiving member further comprises a collar extending around the open face of the rectangular-shaped box, the locking mechanism further comprising means for rigidly connecting the collar to said one of the top wall, bottom wall and sidewalls of the cremation urn.

10. A locking mechanism according to claim 9, wherein the means for rigidly connecting the collar comprise screws.

11. A locking mechanism according to claim 1, wherein the female receiving member is in the bottom wall of the cremation urn.
